(19) United States
(12) Patent Application Publication
(10) Pub. No.: US 2026/0276053 A1
(43) Pub. Date: Sep. 17, 2026

(54) SHOCK ABSORBING DEVICE AND SUSPENSION DEVICE

(71) Applicant: Astemo, Ltd., Tokyo (JP)

(72) Inventors: Gota NAKANO, Hitachinaka-shi (JP); Seiryo KONAKAI, Hitachinaka-shi (JP)

(73) Assignee: Astemo, Ltd., Tokyo (JP)

(21) Appl. No.: 19/166,369

(22) PCT Filed: May 2, 2023
(86) PCT No.: PCT/JP2023/017106

§ 371 Date: Sep. 17, 2025

(51) Int. Cl. F16F 9/49; B60G 15/06; B60G 17/08; F16F 9/19; F16F 9/32; F16F 9/36; F16F 13/00

(52) U.S. Cl. CPC F16F 9/49; B60G 15/062; B60G 17/08; F16F 9/19; F16F 9/3242; F16F 9/368; F16F 13/007; B60G 2202/312; B60G 2204/45; B60G 2206/41; B60G 2500/10; B60G 2600/21; B60G 2800/162; B60G 2800/916; F16F 2222/12; F16F 2228/066; F16F 2230/007; F16F 2230/02; F16F 2230/30; F16F 2230/42; F16F 2232/08; F16F 2234/02

(57) ABSTRACT

A shock absorbing device includes: an annular elastic member; a seal member disposed on a side opposite a first piston unit and capable of contacting an inner peripheral surface of a collar; and a restricting member to restrict axial movement of the elastic member and the seal member. The seal member includes: a base portion; and a projection protruding annularly toward the elastic member from an opposing surface facing the elastic member and capable of contacting an outer periphery of the elastic member. The base portion includes recesses formed inward of the projection and recessed from the opposing surface to a side opposite the elastic member. The projection includes a groove formed in at least a portion thereof to provide communication between inside and outside of the projection.

### CROSS-REFERENCE TO RELATED PATENT APPLICATIONS

This application is a U.S. National Phase Application under 35 U.S.C. § 371 of International Patent Application No. PCT/JP 2023/017106 filed on May 2, 2023, the content of which is incorporated herein by reference in its entirety. The International Patent Application was published in Japanese on Nov. 7, 2024 as International Publication No. WO/2024/228248 under PCT Article 21(2).

### FIELD OF THE INVENTION

The present invention relates to a shock absorbing device and a suspension device.

### BACKGROUND OF THE INVENTION

For example, a vibration damper disclosed in DE102019206510A is configured as follows. Specifically, a first piston is secured to a piston rod that is axially movable within a cylinder. A second piston is attached to the piston rod. The second piston enters a pressure cylinder with a pressure chamber, depending on the stroke. The second piston has a throttle opening, through which a damping medium flows. At the center of the bottom of the pressure cylinder, there is located a pressure relief valve with a pin axially penetrating the bottom, the pressure relief valve being configured to open in the direction of flow from the pressure cylinder to the base valve body. The pressure relief valve includes a spherical valve and a spring configured to apply force on the valve to close the flow path.

### CITATION LIST

### Patent Literature

Patent Literature 1: DE102019206510A

### Technical Problem

The pressure relief valve disclosed in DE102019206510A opens in response to the internal pressure reaching a preset level during a compression stroke, in which the piston rod moves into the cylinder. This causes the damping medium to flow out from the pressure cylinder, thereby preventing the pressure inside the cylinder from becoming excessively high. Since the pressure relief valve is located at the bottom of the pressure cylinder, it is not suitable for use for extension strokes, in which the piston rod moves out of the cylinder. If the valve is to be used for extension strokes, the vertical orientation of the cylinder must be reversed. In such cases, an additional hole would be required at the bottom of the cylinder to allow the piston rod to pass therethrough. To ensure proper functioning of the pressure relief valve, an airtight sealing process must be performed to establish an airtight seal between the hole and the piston rod. Further, to prevent the pressure relief valve from interfering with the piston rod, the pressure relief valve would need to be located offset from the piston rod.

It is an object of the present invention to provide a shock absorbing device and the like that offer good layout flexibility and also allow for flexible setting of damping force characteristics by preventing an excessive pressure increase within the cylinder during extension strokes.

### SUMMARY OF THE INVENTION

### Solution to Problem

With the above object in view, an aspect of the present invention provides a shock absorbing device. The shock absorbing device includes: a rod configured to have a portion thereof inserted into a cylinder of a cylindrical shape; a first piston unit configured to be secured to the rod and to partition a space inside the cylinder; a collar of a cylindrical shape disposed within the cylinder closer to the rod than the first piston unit; and a second piston unit configured to be secured to the rod coaxially with the first piston unit, to enter the collar and to be capable of forming a high-pressure chamber within a space inside the collar, the high-pressure chamber being at a higher pressure than in a space closer to the first piston unit. The second piston unit includes: an elastic member of an annular shape having elasticity; a seal member disposed on a side opposite the first piston unit with respect to the elastic member in an axial direction of the rod, the seal member being configured to be capable of contacting an inner peripheral surface of the collar; and a restricting member configured to restrict movement of the elastic member and the seal member in the axial direction. The seal member includes: a base portion of a cylindrical shape; and a projection protruding annularly toward the elastic member from an outer periphery of an opposing surface of the base portion, the opposing surface facing the elastic member, the projection being configured to be capable of contacting an outer periphery of the elastic member. The base portion includes a recess formed at a position inward of the projection, the recess being recessed from the opposing surface to a side opposite the elastic member. The projection includes a groove formed in at least a portion thereof in a circumferential direction, the groove being configured to provide communication between inside and outside of the projection.

### Advantageous Effects of Invention

The present invention can provide a shock absorbing device and the like that offer good layout flexibility and also allow for flexible setting of damping force characteristics by preventing an excessive pressure increase within the cylinder during extension strokes.

### BRIEF DESCRIPTION OF THE DRAWINGS

FIG. 1 is a diagram that illustrates an example schematic configuration of a suspension device.

FIG. 2 is an example of an enlarged view of part II in FIG. 1.

FIG. 3 is a diagram that illustrates an example view of a seal member from the first side in the axial direction.

FIG. 4 is an example of a cross-section of a second piston unit during an extension stroke, in which the amount of protrusion of a rod from a cylinder unit increases.

FIG. 5 is an example of an enlarged view of part V in FIG. 4.

FIG. 6 is an example of a cross-section of the second piston unit during an extension stroke.

FIG. 7 is an example of a cross-section of the second piston unit during a compression stroke, in which the protruding amount of the rod decreases.

FIG. 8 is an example showing a schematic configuration of a second piston unit according to a second embodiment.

FIG. 9 is an example showing a state of the second piston unit during a compression stroke, in which the protruding amount of the rod decreases.

FIG. 10 is an example showing a schematic configuration of a second piston unit according to a third embodiment.

FIG. 11 is an example showing an axial view of an elastic member according to the third embodiment.

FIG. 12 is an example showing a schematic configuration of a shock absorbing device according to a fourth embodiment.

FIG. 13 is an example showing a cross-section of a third piston unit during a compression stroke.

### DETAILED DESCRIPTION OF THE INVENTION

Embodiments of the present invention will be described below in detail with reference to the appended drawings.

### First Embodiment

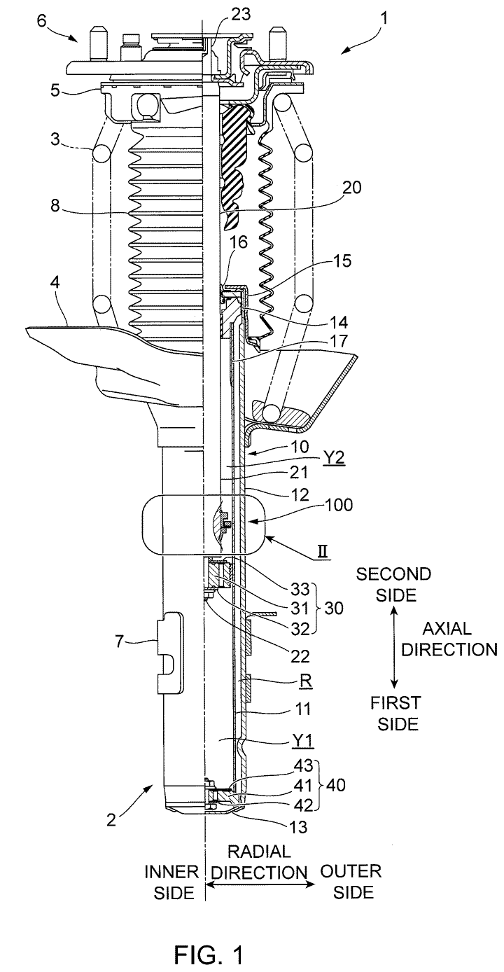

FIG. 1 illustrates an example schematic configuration of a suspension device 1.

The suspension device 1 is a suspension strut used in four-wheeled vehicles such as passenger cars and, as shown in FIG. 1, includes a shock absorbing device 2 and a coil spring 3 disposed outside the shock absorbing device 2. The suspension device 1 further includes a lower spring seat 4 and an upper spring seat 5. The lower spring seat 4 supports an end of the coil spring 3 on the first side (lower side in FIG. 1) in the axial direction of a rod 20 (described below), and the upper spring seat 5 supports the other end of the coil spring 3 on the second side (upper side in FIG. 1) in the axial direction.

The suspension device 1 includes a vehicle body-side attaching bracket 6 and a wheel-side attaching bracket 7. The vehicle body-side attaching bracket 6 is attached to a second side end of the rod 20 in the axial direction for attaching the suspension device 1 to the vehicle, and the wheel-side attaching bracket 7 is secured to a first side end of a cylinder unit 10 (described below) in the axial direction of the rod 20 for attaching the suspension device 1 to a wheel. The suspension device 1 further includes a dust cover 8 to cover at least portions of the cylinder unit 10 and the rod 20.

The axial direction of the rod 20 may be simply referred to hereinafter as the “axial direction.” The axial direction also corresponds to the centerline direction of a cylinder 11 of a cylindrical shape (described below). The first side in the axial direction (the lower side in FIG. 1) and the second side in the axial direction (the upper side in FIG. 1) may be simply referred to as the “first side” and the “second side,” respectively. The direction intersecting the axial direction (e.g., perpendicular direction) is referred to as the “radial direction.” In the radial direction, the side closer to the centerline of the cylinder 11 may be simply referred to as the “inside,” and the side farther from the centerline may be referred to as the “outside.” The shock absorbing device 2 is now detailed.

The shock absorbing device 2 includes a cylinder unit 10 for containing oil and the rod 20 with its second side end protruding from the cylinder unit 10 and its first side end slidably inserted in the cylinder unit 10. The shock absorbing device 2 further includes a first piston unit 30 disposed at the first side end of the rod 20 and a bottom valve 40 disposed at the first side end of the cylinder unit 10. The shock absorbing device 2 further includes a second piston unit 100 disposed at the second side relative to the first piston unit 30.

### [Cylinder Unit 10]

The cylinder unit 10 includes a cylinder 11 for containing oil, an outer cylindrical body 12 disposed outside of the cylinder 11, and a bottom lid 13 for closing the first side end of the outer cylindrical body 12. The cylinder 11 and the outer cylindrical body 12 are arranged such that the centerline direction of these cylinders coincides with the axial direction. The cylinder unit 10 includes a reservoir chamber R formed between the outer peripheral surface of the cylinder 11 and the inner peripheral surface of the outer cylindrical body 12. Oil, which is an example of the fluid, is filled inside the outer cylindrical body 12.

The cylinder unit 10 further includes a rod guide unit 14 for movably supporting the rod 20, a bump stopper cap 15 attached to the second side end of the outer cylindrical body 12, and an oil seal 16 for preventing oil from leaking through the cylinder unit 10 and foreign matters from entering the cylinder unit 10. The cylinder unit 10 further includes a collar 17 disposed at the second side end of the cylinder 11. The collar 17 has a cylindrical shape and is chamfered at its first side end such that its inner diameter gradually increases toward the first side. Providing the collar 17 of such a cylindrical shape and omitting a pressure control valve, such as one disclosed in DE102019206510A, eliminates the need for providing a hole for passage of the rod 20 therethrough as well as for performing an airtight sealing process, thereby improving layout flexibility. By way of example, the collar 17 may be joined to the cylinder 11 by welding or adhesion.

### [Rod 20]

The rod 20 is a solid or hollow rod-shaped member and includes a columnar or cylindrical rod portion 21. The rod 20 also includes a lower attaching portion 22 at its lower end for attachment of the first piston unit 30, and an upper attaching portion 23 at its upper end for attachment of the vehicle body-side attaching bracket 6. Male threads are formed at the ends of the lower and upper attaching portions 22, 23.

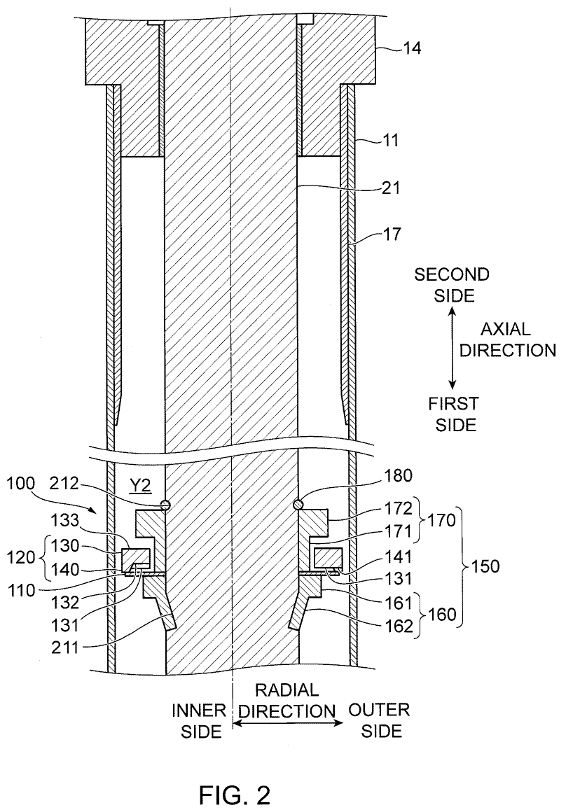

The rod portion 21 includes a first groove 211 (see FIG. 2) and a second groove 212 (see FIG. 2) formed at predetermined positions on the rod portion 21, each being recessed from the outer peripheral surface of the rod portion 21 over its entire circumference. The first groove 211 has a triangular cross-section when taken along a plane parallel to the axial direction, while the second groove 212 has a semicircular cross-section when taken along a plane parallel to the axial direction.

### [First Piston Unit 30]

The first piston unit 30 includes a first piston 31, a valve group 32 for closing first side ends of some of multiple oil paths formed in the first piston 31, and a valve group 33 for closing second side ends of some of these oil paths formed in the first piston 31.

The first piston 31 contacts the inner peripheral surface of the cylinder 11 via a member provided on the outer peripheral surface of the first piston 31 to seal a gap between the outer peripheral surface of the first piston 31 and the inner peripheral surface of the cylinder 11, thereby partitioning the space inside the cylinder 11 filled with oil into a first oil chamber Y1 located on the first side relative to the first piston 31 and a second oil chamber Y2 located on the second side relative to the first piston 31.

### [Bottom Valve 40]

The bottom valve 40 includes a valve body 41 with multiple oil paths extending axially therethrough, a valve 42 provided on the first side of the valve body 41, and a valve 43 provided on the second side of the valve body 41.

The valve body 41 of the bottom valve 40 provides a partition between the first oil chamber Y1 and the reservoir chamber R.

### [Second Piston Unit 100]

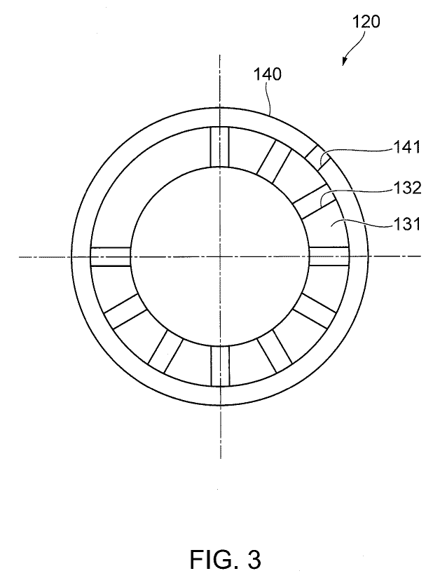

FIG. 2 is an example enlarged view of part II in FIG. 1.
FIG. 3 illustrates an example view of a seal member 120 from the first side in the axial direction.

The second piston unit 100 includes an elastic member 110 of an annular shape having elasticity and a seal member 120 disposed on the side opposite the first piston unit 30 (i.e., on the second side) with respect to the elastic member 110 in the axial direction of the rod 20 and capable of contacting the inner peripheral surface of the collar 17. The second piston unit 100 further includes a restricting member 150 for restricting the axial movement of the elastic member 110 and the seal member 120, and a clip 180 for restricting the axial movement of the restricting member 150. The clip 180 has a circular cross-section and has a C-shape when viewed in the axial direction.

### (Elastic Member 110)

The elastic member 110 is, for example, an annular plate made of metal. The elastic member 110 has an inner diameter greater than or equal to a diameter of the outer peripheral surface of the rod portion 21 of the rod 20, and has an outer diameter smaller than a diameter of the inner peripheral surface of the collar 17.

### (Seal Member 120)

The seal member 120 is, for example, a cylindrical member made of metal or resin. More specifically, the seal member 120 includes a base portion 130 of a cylindrical shape and a projection 140 protruding annularly toward the elastic member 110 (i.e., toward the first side) from the outer periphery of an opposing surface 131 of the base portion 130 facing the elastic member 110.

The base portion 130 has an inner diameter greater than the diameter of the outer peripheral surface of the rod portion 21 of the rod 20, and has an outer diameter equal to the diameter of the inner peripheral surface of the collar 17. The base portion 130 includes multiple (ten in the example shown in FIG. 3) recesses 132 formed along the circumferential direction at positions inward of the projection 140, the recesses 132 being recessed from the opposing surface 131 toward the side opposite the elastic member 110 (i.e., toward the second side).

The projection 140 has a rectangular cross-section when taken along a plane parallel to the axial direction, in which the radial direction corresponds to the longitudinal direction of the rectangle and the axial direction corresponds to the transverse direction of the rectangle. However, the inner peripheral surface of the projection 140 may be an inclined surface whose inner diameter increases toward the first side. This is because such an inclined surface facilitates smooth flow of oil along the inclined surface.

The projection 140 includes a groove 141 extending in the radial direction so as to provide communication between portions inside and outside of the projection 140. The groove 141 is formed at a position where it does not overlap the recesses 132 in the circumferential direction. In the example shown in FIG. 3, a single groove 141 is formed; however, the number of grooves 141 is not limited to one, and there may be multiple grooves 141. However, the total cross-sectional area of the one or more grooves 141, when taken along a plane perpendicular to the axial direction, is smaller than the total cross-sectional area of the multiple recesses 132.

### (Restricting Member 150)

The restricting member 150 includes a first member 160 and a second member 170 arranged in the axial direction. By way of example, the restricting member 150 may be made of metal or resin.

The first member 160 includes a cylindrical portion 161 of a cylindrical shape and a protruding portion 162 protruding toward the inside from the lower end of the cylindrical portion 161.

The cylindrical portion 161 has an inner diameter greater than or equal to the diameter of the outer peripheral surface of the rod portion 21 of the rod 20. The cylindrical portion 161 has an outer diameter smaller than the diameter of the inner peripheral surface of the collar 17 and greater than inner diameters of the elastic member 110 and the seal member 120.

The protruding portion 162 protrudes in an axially inclined direction from the lower end of the cylindrical portion 161 over the entire circumference thereof. The distal end of the protruding portion 162 is fitted into the first groove 211 of the rod portion 21, thereby holding the first member 160 on the rod 20 so as not to move relative to it.

The second member 170 includes a first cylindrical portion 171 of a cylindrical shape and a second cylindrical portion 172 of a cylindrical shape provided on the second side relative to the first cylindrical portion 171. The first and second cylindrical portions 171, 172 have the same inner diameter that is greater than or equal to the diameter of the outer peripheral surface of the rod portion 21. The second cylindrical portion 172 has an outer diameter larger than that of the first cylindrical portion 171. The outer diameter of the first cylindrical portion 171 is smaller than the inner diameter of the seal member 120. The outer diameter of the second cylindrical portion 172 is smaller than the diameter of the inner peripheral surface of the collar 17 and greater than the inner diameter of the seal member 120.

The restricting member 150 according to the present embodiment is mounted on the rod 20 with the inner periphery of the elastic member 110 sandwiched between the first member 160 and the second member 170. As the protruding portion 162 of the first member 160 is fitted onto the first groove 211 of the rod portion 21, the first member 160 is held on the rod 20 so as not to move relative to it, and movement of the second member 170 toward the second side is restricted by the clip 180. As a result, the inner periphery of the elastic member 110 serves as a fixed end, while its outer periphery serves as a free end.

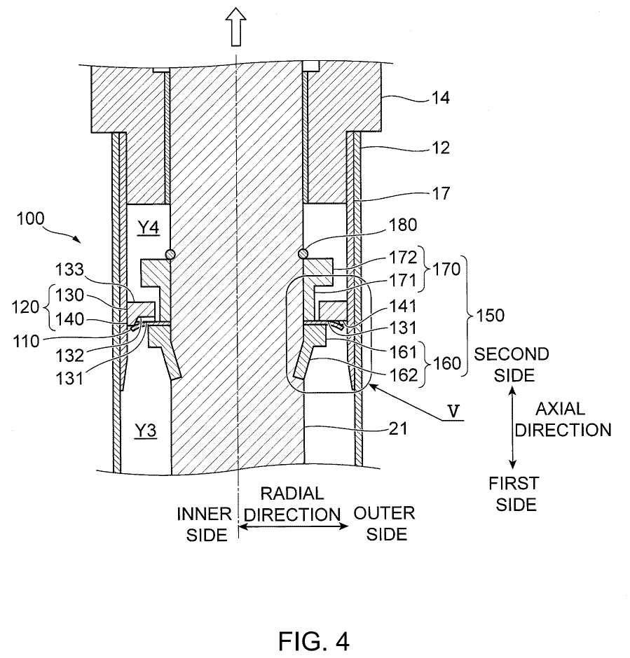

(Functions of the Second Piston Unit 100) FIG. 4 illustrates an example cross-section of the second piston unit 100 during an extension stroke, in which the amount of protrusion (which may be referred to hereinafter as the “protruding amount”) of the rod 20 from the cylinder unit 10 increases.

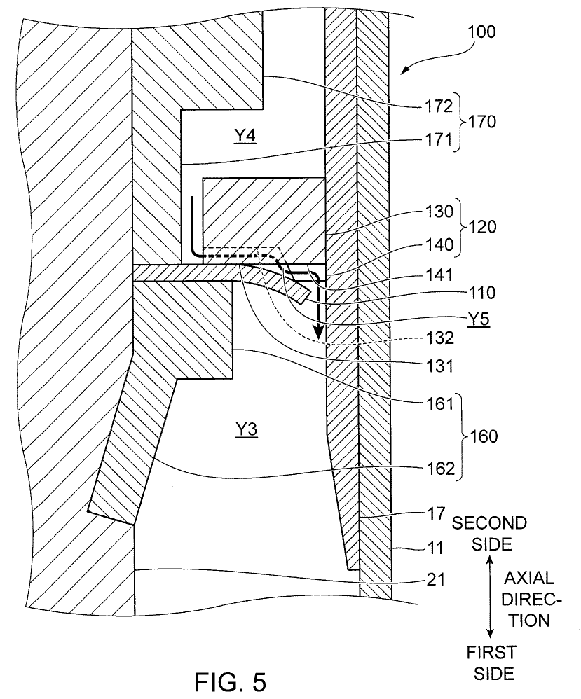

FIG. 5 is an example enlarged view of part V in FIG. 4.

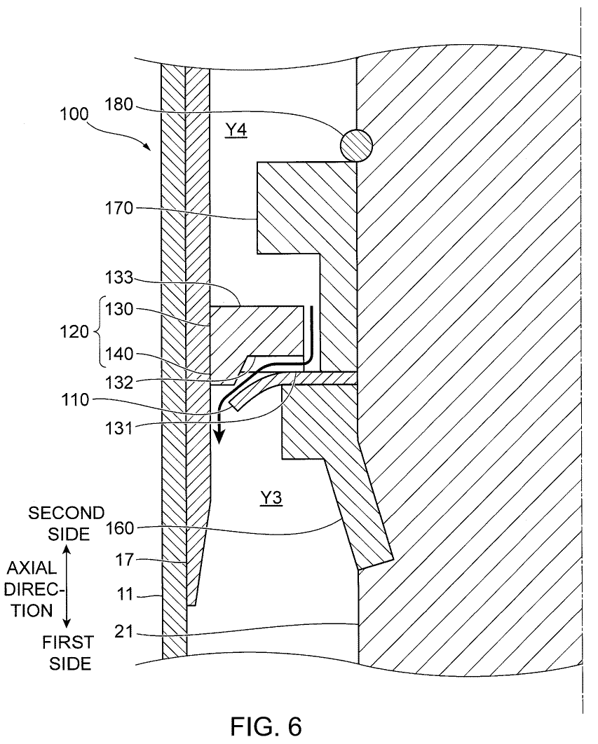

FIG. 6 illustrates an example cross-section of the second piston unit 100 during an extension stroke.

During an extension stroke, in which the protruding amount of the rod 20 from the cylinder unit 10 increases, the movement of the second piston unit 100 from a position on the first side relative to the collar 17 (the state shown in FIG. 2) to the second side causes the seal member 120 to enter the collar 17 and come into contact with the inner peripheral surface of the collar 17. This results in the formation of a high-pressure chamber within the space inside the collar 17; the high-pressure chamber is at a higher pressure than a space located within the second chamber Y2 and closer to the first piston unit 30 than the seal member 120 (i.e., on the first side relative to the seal member 120). Hereinafter, the space located within the collar 17 and on the first side relative to the seal member 120 may be referred to as a “third chamber Y3,” and the space located within the collar 17 and on the second side relative to the seal member 120 may be referred to as a “fourth chamber Y4.” The fourth chamber Y4 corresponds to the high-pressure chamber described above.

When the pressure in the fourth chamber Y4 increases and the force acting on a second side end face 133 of the seal member 120 becomes greater than that acting on the first side portions of the seal member 120 and the elastic member 110, the seal member 120 deforms the outer periphery of the elastic member 110. This results in the opposing surface 131 of the seal member 120 coming into contact with the elastic member 110 as shown in FIGS. 4 and 5, thus sandwiching the elastic member 110 between the seal member 120 and the cylindrical portion 161 of the first member 160.

In the state shown in FIGS. 4 and 5, a portion of oil in the fourth chamber Y4 flows via the recesses 132 of the seal member 120 into a fifth chamber Y5, which is a space surrounded by the opposing surface 131 of the seal member 120, the inner peripheral surface of the projection 140, and the elastic member 110. Then, as shown in FIG. 5, a portion of oil in the fifth chamber Y5 flows out to the third chamber Y3 through the groove 141 formed in the projection 140 of the seal member 120. In this manner, damping force is generated as the oil flows out to the third chamber Y3 via the groove 141. The groove 141 functions as an orifice that allows the oil to flow from the fourth chamber Y4 to the third chamber Y3.

When the pressure in the fifth chamber Y5 further increases in the state shown in FIGS. 4 and 5, the outer periphery of the elastic member 110 deforms further, causing it to separate from the projection 140, as shown in FIG. 6. This causes oil to flow out from the fifth chamber Y5 to the third chamber Y3. In the state shown in FIG. 6, damping force is generated as oil flows from the fourth chamber Y4 to the third chamber Y3 via the recesses 132 of the seal member 120. Thus, even with the collar 17 configured as a cylindrical body, the second piston unit 100 fulfills both the orifice function shown in FIGS. 4 and 5 and the blow-off valve function shown in FIG. 6, providing both layout flexibility and damping characteristics.

To ensure that the elastic member 110 separates from the projection 140 after the seal member 120 deforms the outer periphery of the elastic member 110 and the pressure in the fourth chamber Y4 becomes higher than that in the third chamber Y3 by a predetermined value, the flow path areas of the recesses 132 and the groove 141 (i.e., the cross-sectional areas taken along a plane perpendicular to the axial direction) are set as follows. Specifically, the total flow pass area formed by the groove 141 and the elastic member 110 when the opposing surface 131 and the projection 140 come into contact with the elastic member 110 is smaller than the total flow path area formed by the recesses 132 and the elastic member 110.

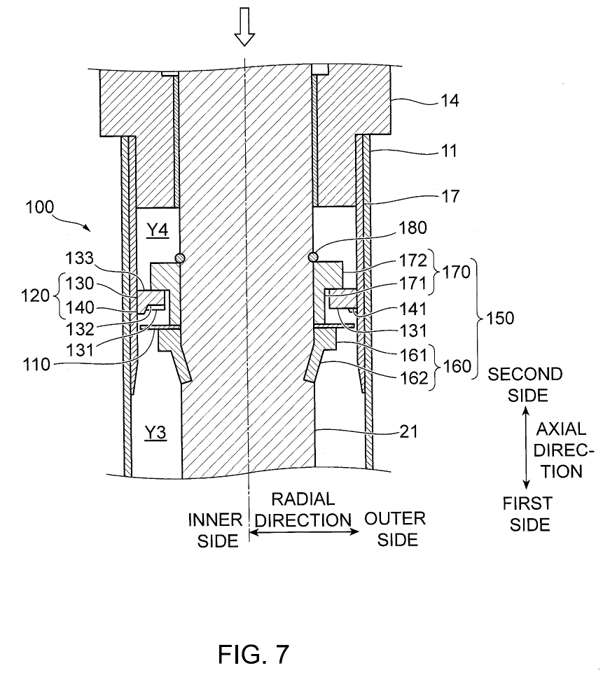

FIG. 7 illustrates an example cross-section of the second piston unit 100 during a compression stroke, in which the protruding amount of the rod 20 decreases.

As shown in FIG. 7, during a compression stroke, in which the protruding amount of the rod 20 from the cylinder unit 10 decreases, when the force acting on the first side portion of the seal member 120 becomes greater than that acting on the second side end face 133 of the seal member 120, the seal member 120 moves toward the second side and butts against the second cylindrical portion 172. The movement of the seal member 120 toward to the first side relative to the collar 17 allows oil to flow around the outside of the seal member 120, resulting in equalization of the pressure inside the spaces on the first side and the second side relative to the seal member 120.

As described above, the shock absorbing device 2 includes: the rod 20 having a portion thereof inserted into the cylinder 11 of a cylindrical shape; the first piston unit 30 secured to the rod 20 and partitioning the space inside the cylinder 11; and the collar 17 of a cylindrical shape disposed within the cylinder 11 and closer to the rod 20 (i.e., on the second side) relative to the first piston unit 30. The shock absorbing device 2 further includes the second piston unit 100 secured to the rod 20 coaxially with the first piston unit 30 and capable of entering the collar 17 to form the fourth chamber Y4, as an example of the high-pressure chamber, in the space within the collar 17, where the pressure in the fourth chamber Y4 is higher than that in the space closer to the first piston unit. The second piston unit 100 includes: the elastic member 110 of an annular shape having elasticity; the seal member 120 disposed on the opposite side of the first piston unit 30 with respect to the elastic member 110 in the axial direction of the rod 20 and capable of contacting the inner peripheral surface of the collar 17; and the restricting member 150 restricting the axial movement of the elastic member 110 and the seal member 120. The seal member 120 includes: the base portion 130 of a cylindrical shape; and the projection 140 protruding annularly from the outer periphery of the opposing surface 131 of the base portion 130, which faces the elastic member 110, toward the elastic member 110 and capable of contacting the outer periphery of the elastic member 110. The base portion 130 includes the recesses 132 formed at positions inward of the projection 140, the recesses 132 being recessed from the opposing surface 131 toward the side opposite the elastic member 110. The projection 140 includes the groove 141 formed in at least a portion thereof in the circumferential direction, the groove 141 providing communication between the inside and the outside of the projection 140.

It is desirable for the shock absorbing device 2 to generate a high damping force during an extension stroke. For example, such a high damping force helps suppress the lifting of the inner wheel during cornering, which in turn reduces body roll and contributes to improved ride comfort. In the shock absorbing device 2, the second piston unit 100 forms a high-pressure chamber (i.e., the fourth chamber Y4) within the collar 17 during an extension stroke, providing a higher damping force compared to, e.g., a configuration without the second piston unit 100.

On the other hand, an excessively high damping force during an extension stroke may result in a stiff ride, which could conversely worsen ride comfort. In the shock absorbing device 2, when the second piston unit 100 forms a high-pressure chamber within the collar 17 during an extension stroke, the groove 141 functions as an orifice to allow oil to flow from the fourth chamber Y4 to the third chamber Y3. This configuration can prevent the damping force from becoming excessively high.

In addition, the shock absorbing device 2 allows the damping force to be adjusted by altering the flow path areas of the groove 141 and the recesses 132, enabling flexible setting of the damping force characteristics. Furthermore, the second piston unit 100 is composed of the elastic member 110, the seal member 120, and the restricting member 150. This configuration enables the shock absorbing device 2 to provide the above-described effects at low cost.

In the first embodiment, the restricting member 150 includes the first member 160 and the second member 170 arranged in the axial direction, and the elastic member 110 is sandwiched between the first member 160 and the second member 170. This configuration can prevent the axial movement of the elastic member 110, enabling rapid transition from a compression stroke to an extension stroke or vice versa.

However, the elastic member 110 does not necessarily have to be sandwiched between the first member 160 and the second member 170. For example, the inner diameter of the elastic member 110 may be set smaller than that of the seal member 120 and greater than that of the first cylindrical portion 171 of the second member 170 to allow the elastic member 110 to move between the first member 160 and the seal member 120.

### Second Embodiment

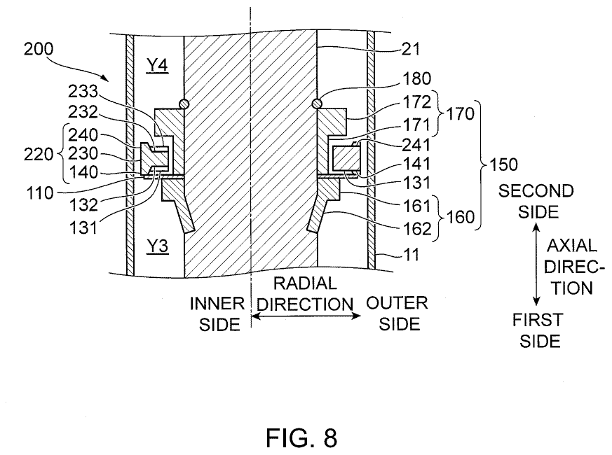

FIG. 8 illustrates an example schematic configuration of a second piston unit 200 according to a second embodiment.

A distinction of the second piston unit 200 according to the second embodiment from the second piston unit 100 according to the first embodiment relates to a seal member 220, which corresponds to the seal member 120. The distinction from the first embodiment is described below. The same reference numerals are used to identify the same elements between the first and second embodiments, and detailed descriptions thereof are omitted.

The seal member 220 differs from the seal member 120 in that the seal member 220 is symmetrical with respect to a plane perpendicular to the axial direction. Specifically, the seal member 220 includes a base portion 230, which corresponds to the base portion 130 according to the first embodiment, the projection 140, and another projection 240 protruding annularly toward the second side from the outer periphery of a second side end face 233 of the base portion 230.

The projection 240 is symmetrical to the projection 140 with respect to a plane perpendicular to the axial direction. The projection 240 includes a groove 241 extending in the radial direction so as to provide communication between the inside and the outside of the projection 240.

The base portion 230 differs from the base portion 130 according to the first embodiment in that the base portion 230 includes multiple (e.g., ten) recesses 232 formed along the circumferential direction at positions inward of the projection 240, the recesses 232 being recessed from the end face 233 toward the first side. The recesses 232 are symmetrical to the recesses 132 with respect to a plane perpendicular to the axial direction. The base portion 230 is also symmetrical with respect to a plane perpendicular to the axial direction.

The second piston unit 200 according to the second embodiment provides the same effects as those provided by the second piston unit 100 according to the first embodiment described above. In addition, the second piston unit 200 includes the seal member 220 having a symmetrical shape with respect to a plane perpendicular to the axial direction. This allows the seal member 220 to be assembled without concern for its orientation. This facilitates the assembly of the second piston unit 200.

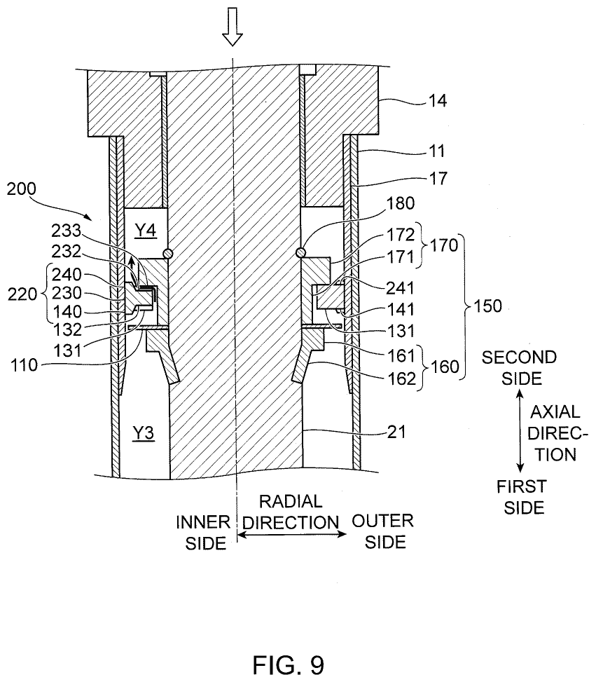

FIG. 9 illustrates an example state of the second piston unit 200 during a compression stroke, in which the protruding amount of the rod 20 decreases.

Even when the seal member 220 is located inside the collar 17 during the compression stroke, oil flows from the third chamber Y3 to the fourth chamber Y4 through the recesses 232 of the seal member 220 while the end face 233 of the seal member 220 is in contact with the second cylindrical portion 172. This facilitates a smooth transition from an extension stroke to the compression stroke.

### Third Embodiment

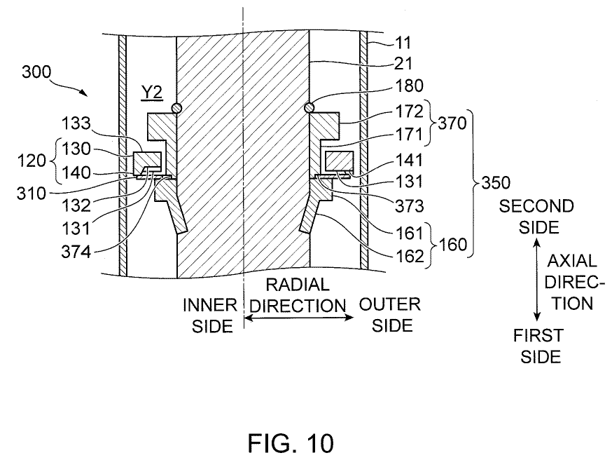

FIG. 10 illustrates an example schematic configuration of a second piston unit 300 according to a third embodiment.

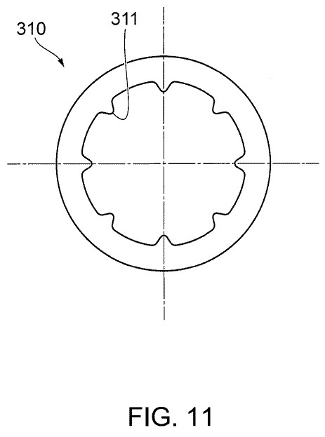

FIG. 11 illustrates an example axial view of an elastic member 310 according to the third embodiment.

Distinctions of the second piston unit 300 according to the third embodiment from the second piston unit 100 according to the first embodiment relate to an elastic member 310 and a restricting member 350, which correspond to the elastic member 110 and the restricting member 150, respectively. The distinctions from the first embodiment are described below. The same reference numerals are used to identify the same elements between the first and third embodiments, and detailed descriptions thereof are omitted.

The restricting member 350 includes the first member 160 and a second member 370, which corresponds to the second member 170. The second member 370 differs from the second member 170 according to the first embodiment in that the second member 370 includes a recess 373 formed at its first side end over the entire circumference, the recess 373 being recessed from the outer peripheral surface of the second member 370. The axial size of the recess 373 is greater than or equal to the thickness of the elastic member 310. The second member 370 is disposed such that its first side end face is capable of contacting the second side end face of the first member 160. In other words, unlike the second piston unit 100 according to the first embodiment, the elastic member 310 is not sandwiched between the first member 160 and the second member 370.

The elastic member 310 differs from the elastic member 110 according to the first embodiment in that the elastic member 310 includes multiple (eight in the example shown in FIG. 11) protruding portions 311 along the circumferential direction, each extending toward the center from the inner peripheral end of the elastic member 310. By way of example, the protruding portions 311 may be formed at equal intervals in the circumferential direction. The radius of a virtual circle defined by the distal ends of the multiple protruding portions 311 is smaller than or equal to a diameter of a portion of an outer peripheral surface 374 of the second member 370 where the recess 373 is formed. The elastic member 310 is secured to the restricting member 350 as the multiple protruding portions 311 grip the outer peripheral surface 374.

The second piston unit 300 according to the third embodiment also provides the same effects as those provided by the second piston unit 100 according to the first embodiment described above. In addition, the elastic member 310 of the second piston unit 300 includes the protruding portions 311 that grip the outer peripheral surface 374 of the restricting member 350 to secure the elastic member 310 to the restricting member 350. This configuration allows the elastic member 310 and the restricting member 350 to be integrated prior to assembling the second piston unit 300. This facilitates the assembly of the second piston unit 300.

### Fourth Embodiment

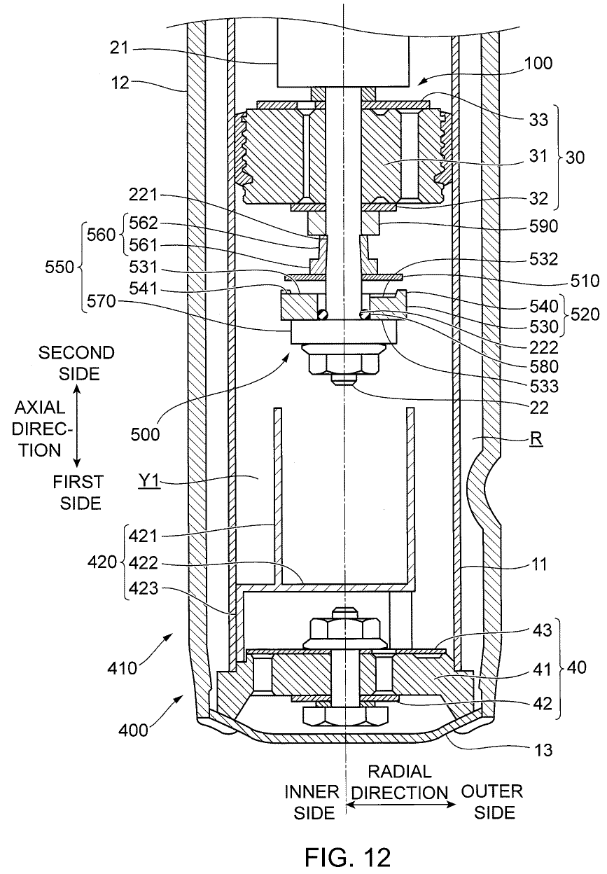

FIG. 12 illustrates an example schematic configuration of a shock absorbing device 400 according to a fourth embodiment.

The shock absorbing device 400 according to a fourth embodiment differs from the shock absorbing device 2 according to the first embodiment in that the shock absorbing device 400 includes a cylinder unit 410, which corresponds to the cylinder unit 10, and a third piston unit 500 that can prevent the pressure inside the cylinder 11 from becoming excessively high during a compression stroke. The distinctions from the first embodiment are described below. The same reference numerals are used to identify the same elements between the first and fourth embodiments, and detailed descriptions thereof are omitted.

The cylinder unit 410 differs from the cylinder unit 10 in that the cylinder unit 410 further includes a second collar 420 at the first side end of the cylinder 11. The second collar 420 is in the shape of a closed-end cylinder and includes a cylindrical portion 421 of a cylindrical shape and a closing portion 422 closing a first side opening of the cylindrical portion 421. The second collar 420 further includes multiple leg portions 423 provided on the first side relative to the closing portion 422.

The cylindrical portion 421 is capable of accommodating the third piston unit 500 and forms a gap between the cylindrical portion 421 and the cylinder 11.

Each leg portion 423 extends in the radial direction and toward the first side from an outer portion of the closing portion 422. When viewed in the axial direction, the portion of each leg portion 423 extending toward the first side has an arc shape. Multiple (e.g., three) leg portions 423 are provided at equal intervals in the circumferential direction.

The second collar 420 is secured to the first side end of the inside of the cylinder 11 as the leg portions 423 are joined to the cylinder 11 by, e.g., welding or adhesion. The leg portions 423 are positioned outside of the valve 43, and the closing portion 422 is positioned on the second side relative to the bottom valve 40. The wall thickness of each portion of the second collar 420 may be kept to a minimum as the second collar 420 only needs to accommodate the third piston unit 500.

The third piston unit 500 includes an elastic member 510 of an annular shape having elasticity and a seal member 520 disposed on the side opposite the first piston unit 30 (i.e., on the first side) with respect to the elastic member 510 in the axial direction and capable of contacting the inner peripheral surface of the cylindrical portion 421 of the second collar 420. The third piston unit 500 further includes a first restricting member 550 for restricting the axial movement of the elastic member 510 and the seal member 520. The third piston unit 500 further includes an annular second restricting member 590 for restricting the axial movement of the first piston unit 30.

### (Elastic Member 510)

The elastic member 510 is, for example, an annular plate made of metal. The elastic member 510 has an inner diameter greater than or equal to a diameter of the outer peripheral surface of the lower attaching portion 22 of the rod 20, and has an outer diameter smaller than a diameter of the inner peripheral surface of the cylindrical portion 421 of the second collar 420.

### (Seal Member 520)

The seal member 520 is, for example, a cylindrical member made of metal or resin. More specifically, the seal member 520 includes a base portion 530 of a cylindrical shape and a projection 540 protruding annularly toward the elastic member 510 (i.e., toward the second side) from the outer periphery of an opposing surface 531 of the base portion 530 facing the elastic member 510.

The base portion 530 has an outer diameter substantially equal to the diameter of the inner peripheral surface of the cylindrical portion 421 of the second collar 420. The base portion 530 includes multiple (e.g., ten) recesses 532 formed along the circumferential direction at positions inward of the projection 540, the recesses 532 being recessed from the opposing surface 531 toward the side opposite the elastic member 510 (i.e., toward the first side).

The projection 540 has a rectangular cross-section when taken along a plane parallel to the axial direction, in which the radial direction corresponds to the longitudinal direction of the rectangle and the axial direction corresponds to the transverse direction of the rectangle. However, the inner peripheral surface of the projection 540 may be an inclined surface whose inner diameter increases toward the second side. This is because such an inclined surface facilitates smooth flow of oil along the inclined surface.

The projection 540 includes a groove 541 extending in the radial direction so as to provide communication between portions inside and outside of the projection 540. The groove 541 is formed at a position where it does not overlap the recesses 532 in the circumferential direction. Either a single or multiple grooves 541 may be formed. However, the total cross-sectional area of the one or more grooves 541, when taken along a plane perpendicular to the axial direction, is smaller than the total cross-sectional area of the multiple recesses 532.

### (First Restricting Member 550)

The first restricting member 550 includes a first member 560 and a second member 570 arranged in the axial direction. By way of example, the first restricting member 550 may be made of metal or resin.

The first member 560 includes a cylindrical portion 561 of a cylindrical shape and a protruding portion 562 protruding toward the inside from the upper end of the cylindrical portion 561.

The cylindrical portion 561 has an inner diameter greater than or equal to the diameter of the outer peripheral surface of the lower attaching portion 22 of the rod 20. The cylindrical portion 561 has an outer diameter smaller than an outer diameter of the elastic member 510 and greater than inner diameters of the elastic member 510 and the seal member 520.

The protruding portion 562 protrudes in an axially inclined direction from the upper end of the cylindrical portion 561 over the entire circumference thereof. The distal end of the protruding portion 562 is fitted into the first groove 211 of the lower attaching portion 22, thereby holding the first member 560 on the rod 20 so as not to move relative to it.

The second member 570 is an annular member. The second member 570 has an inner diameter greater than or equal to the diameter of the outer peripheral surface of the lower attaching portion 22. The second member 570 has an outer diameter smaller than the diameter of the inner peripheral surface of the cylindrical portion 421 of the second collar 420. The second member 570 is restricted from moving toward the second side by e.g., press-fitting or similar method. As shown in FIG. 12, the movement of the second member 570 toward the second side may also be restricted by a clip 580 fitted into a second groove 222 formed on the outer peripheral surface of the lower attaching portion 22.

### (Functions of the Third Piston Unit 500)

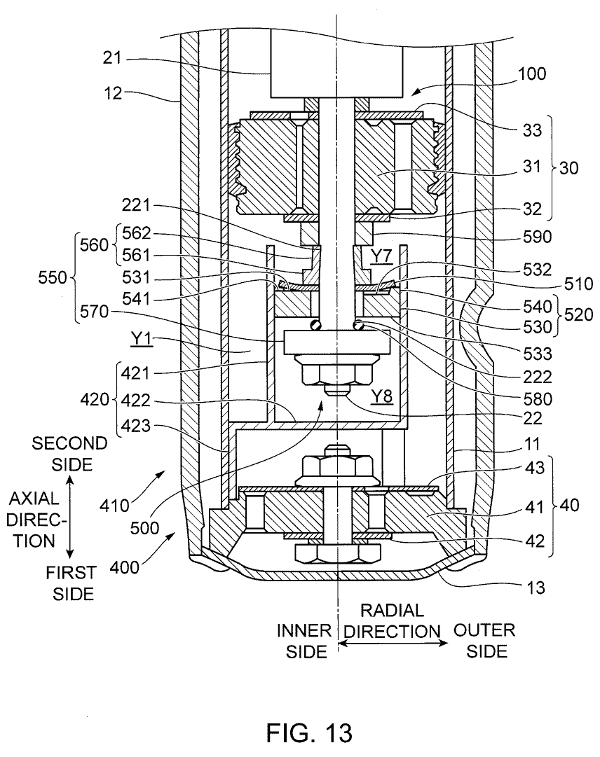

FIG. 13 illustrates an example cross-section of the third piston unit 500 during a compression stroke.

During a compression stroke, the movement of the third piston unit 500 from a position on the second side relative to the second collar 420 (the state shown in in FIG. 12) to the first side causes the seal member 520 to enter the second collar 420 and come into contact with the inner peripheral surface of the cylindrical portion 421 of the second collar 420. This results in the formation of a high-pressure chamber within the space inside the cylindrical portion 421; the high-pressure chamber is at a higher pressure than a space located within the first chamber Y1 and closer to the first piston unit 30 than the seal member 520 (i.e., on the second side relative to the seal member 520). Hereinafter, the space located within the cylindrical portion 421 and on the second side relative to the seal member 520 may be referred to as a “seventh chamber Y7,” and the space located within the cylindrical portion 421 and on the first side relative to the seal member 520 may be referred to as an “eighth chamber Y8.” The eighth chamber Y8 corresponds to the high-pressure chamber described above.

When the pressure in the eighth chamber Y8 increases and the force acting on the first side end face 533 of the seal member 520 becomes greater than that acting on the second side portions of the seal member 520 and the elastic member 510, the seal member 520 deforms the outer periphery of the elastic member 510. This results in the opposing surface 531 of the seal member 520 coming into contact with the elastic member 510 as shown in FIG. 13, thus sandwiching the elastic member 510 between the seal member 520 and the cylindrical portion 561 of the first member 560.

In the state shown in FIG. 13, a portion of oil in the eighth chamber Y8 flows via the recesses 532 of the seal member 520 into a space surrounded by the opposing surface 531 of the seal member 520, the inner peripheral surface of the projection 540, and the elastic member 510. After that, this oil flows out to the seventh chamber Y7 via the groove 541 formed in the projection 540 of the seal member 520. In this manner, damping force is generated as the oil flows out to the seventh chamber Y7 via the groove 541. The groove 541 functions as an orifice that allows the oil to flow from the eighth chamber Y8 to the seventh chamber Y7.

When the pressure in the space surrounded by the opposing surface 531 of the seal member 520, the inner peripheral surface of the projection 540, and the elastic member 510 further increases in the state shown in FIG. 13, the outer periphery of the elastic member 510 deforms further, causing it to separate from the projection 540. This allows oil to flow into the seventh chamber Y7, thereby generating a damping force. Thus, even with the second collar 420 configured to have a minimum wall thickness, the third piston unit 500 fulfills both the orifice function shown in FIG. 13 and the blow-off valve function, providing both layout flexibility and damping characteristics.

To ensure that the elastic member 510 separates from the projection 540 after the seal member 520 deforms the outer periphery of the elastic member 510 and the pressure in the eighth chamber Y8 becomes higher than that in the seventh chamber Y7 by a predetermined value, the flow path areas of the recesses 532 and the groove 541 (i.e., the cross-sectional areas taken along a plane perpendicular to the axial direction) are set as follows. Specifically, the total flow pass area formed by the groove 541 and the elastic member 510 when the opposing surface 531 and the projection 540 come into contact with the elastic member 510 is smaller than the total flow path area formed by the recesses 532 and the elastic member 510.

On the other hand, during an extension stroke, when the force acting on the second side portion of the seal member 520 becomes greater than that acting on the first side end face 533 of the seal member 520, the seal member 520 moves toward the first side and butts against the second member 570. The movement of the seal member 520 toward to the second side relative to the cylindrical portion 421 of the second collar 420 allows oil to flow around the outside of the seal member 520, resulting in equalization of the pressure inside the spaces on the first side and the second side relative to the seal member 520.

In the shock absorbing device 400, the third piston unit 500 forms a high-pressure chamber (i.e., the eighth chamber Y8) within the cylindrical portion 421 of the second collar 420 during a compression stroke, providing a higher damping force compared to, e.g., a configuration without the third piston unit 500. When the third piston unit 500 forms a high-pressure chamber within the cylindrical portion 421 of the second collar 420 during a compression stroke, the groove 541 functions as an orifice to allow oil to flow from the eighth chamber Y8 to the seventh chamber Y7. This configuration can prevent the damping force from becoming excessively high.

In addition, the shock absorbing device 400 allows the damping force to be adjusted by altering the flow path areas of the groove 541 and the recesses 532, enabling flexible setting of the damping force characteristics. Furthermore, the third piston unit 500 is composed of the elastic member 510, the seal member 520, and the first restricting member 550. This configuration enables the shock absorbing device 400 to provide the above-described effects at low cost.

### REFERENCE SIGNS LIST

1 . . . Suspension device
2, 400 . . . Shock absorbing device
3 . . . Coil spring
10 . . . Cylinder unit
11 . . . Cylinder
17 . . . Collar
20 . . . Rod
30 . . . First piston unit
100, 200, 300 . . . Second piston unit
110, 310 . . . Elastic member
120, 220 . . . Seal member
130, 230 . . . Base portion
131 . . . Opposing surface
132, 232 . . . Recess
140, 240 . . . Projection
141, 241 . . . Groove
150, 350 . . . Restricting member
160 . . . First member
170, 370 . . . Second member
311 . . . Protruding portion
374 . . . Outer peripheral surface
420 . . . Second collar (an example of the collar)
500 . . . Third piston unit (an example of the second piston unit)
Y1 . . . First chamber
Y2 . . . Second chamber
Y3 . . . Third chamber
Y4 . . . Fourth chamber
Y5 . . . Fifth chamber

What is claimed is:

1. A shock absorbing device comprising:
a rod configured to have a portion thereof inserted into a cylinder of a cylindrical shape;
a first piston unit configured to be secured to the rod and to partition a space inside the cylinder;
a collar of a cylindrical shape disposed within the cylinder closer to the rod than the first piston unit; and
a second piston unit configured to be secured to the rod coaxially with the first piston unit, to enter the collar and to be capable of forming a high-pressure chamber within a space inside the collar, the high-pressure chamber being at a higher pressure than in a space closer to the first piston unit, wherein
the second piston unit comprises:
an elastic member of an annular shape having elasticity;
a seal member disposed on a side opposite the first piston unit with respect to the elastic member in an axial direction of the rod, the seal member being configured to be capable of contacting an inner peripheral surface of the collar; and
a restricting member configured to restrict movement of the elastic member and the seal member in the axial direction,
the seal member comprises:
a base portion of a cylindrical shape; and
a projection protruding annularly toward the elastic member from an outer periphery of an opposing surface of the base portion, the opposing surface facing the elastic member, the projection being configured to be capable of contacting an outer periphery of the elastic member,
the base portion includes a recess formed at a position inward of the projection, the recess being recessed from the opposing surface to a side opposite the elastic member, [and]
the projection includes a groove formed in at least a portion thereof in a circumferential direction, the groove being configured to provide communication between inside and outside of the projection, and
the shock absorbing device provides a flow path of a damping medium between the restricting member and the seal member, the flow path being connected to a space surrounded by the opposing surface of the seal member, an inner peripheral surface of the projection, and the elastic member.

2. The shock absorbing device according to claim 1, wherein
the recess and the groove are each formed in at least one location in the seal member, and
a total flow path area formed by the groove and the elastic member when the opposing surface and the projection come into contact with the elastic member is smaller than a total flow path area formed by the recess and the elastic member.

3. The shock absorbing device according to claim 1, wherein the seal member is symmetrical with respect to a plane perpendicular to the axial direction.

4. The shock absorbing device according to claim 1, the elastic member further comprises a protruding portion protruding from an inner peripheral end of the elastic member toward a center, the protruding portion being configured to grip an outer peripheral surface of the restricting member to secure the elastic member to the restricting member.

5. The shock absorbing device according to claim 1, wherein
the restricting member comprises a first member and a second member arranged in the axial direction, and
the elastic member is sandwiched between the first member and the second member.

6. A suspension device comprising:
the shock absorbing device according to claim 1; and
a coil spring disposed outside the shock absorbing device

7. A shock absorbing device comprising:
a rod configured to have a portion thereof inserted into a cylinder of a closed-end cylindrical shape including a bottom and a cylindrical portion;
a first piston unit configured to be secured to the rod and to partition a space inside the cylinder;
a collar of the closed-end cylindrical shape disposed at the bottom so as to open toward the first piston unit; and
a second piston unit configured to be secured to the rod coaxially with the first piston unit, to enter the collar and to be capable of forming a high-pressure chamber within a space inside the collar, the high-pressure chamber being at a higher pressure than in a space closer to the first piston unit, wherein
the second piston unit comprises:
an elastic member of an annular shape having elasticity;
a seal member disposed on a side opposite the first piston unit with respect to the elastic member in an axial direction of the rod, the seal member being configured to be capable of contacting an inner peripheral surface of the collar; and
a restricting member configured to restrict movement of the elastic member and the seal member in the axial direction,
the seal member comprises:
a base portion of a cylindrical shape; and
a projection protruding annularly toward the elastic member from an outer periphery of an opposing surface of the base portion, the opposing surface facing the elastic member, the projection being configured to be capable of contacting an outer periphery of the elastic member,
the base portion includes a recess formed at a position inward of the projection, the recess being recessed from the opposing surface to a side opposite the elastic member, [and]
the projection includes a groove formed in at least a portion thereof in a circumferential direction, the groove being configured to provide communication between inside and outside of the projection, and
the shock absorbing device provides a flow path of a damping medium between the rod and the seal member, the flow path being connected to a space surrounded by the opposing surface of the seal member, an inner peripheral surface of the projection, and the elastic member.
